(19) United States
(12) Patent Application Publication
(10) Pub. No.: US 2025/0305230 A1
(43) Pub. Date: Oct. 2, 2025

(54) ODOR-SEALING CARRIER FOR PET WASTE BAGS

(71) Applicant: Molly & Olly Pet Company, LLC, Lakewood, CO (US)

(72) Inventor: Matthew Terrell, Lakewood, CO (US)

(73) Assignee: Molly & Olly Pet Company, LLC, Lakewood, CO (US)

(21) Appl. No.: 19/237,950

(22) Filed: Jun. 13, 2025

Related U.S. Application Data
(63) Continuation-in-part of application No. 18/298,089, filed on Apr. 10, 2023, now abandoned.
(60) Provisional application No. 63/362,711, filed on Apr. 8, 2022.

(51) Int. Cl. E01H 1/12; A01K 23/00; B65F 1/00; B65H 16/00

(52) U.S. Cl. CPC E01H 1/1206; A01K 23/005; B65F 1/0006; B65H 16/005; E01H 2001/1286

(57) ABSTRACT

Disclosed herein are devices for storing and transporting bags containing pet waste, and for storing and dispensing unused waste bags. An embodiment of the carrier includes a main compartment for storing filled bags of pet waste. The main compartment can be removably sealed by a lid, which when closed, contains the odor from the pet waste. The lid includes a compartment with a bag dispenser and a port for removing individual unused bags. The carrier is made of an odor resistant, crushable, and easy to clean material. The carrier includes a reversibly collapsible or extendible main compartment for ease of transport and storage. The main compartment may be fully collapsed for storage or fully or partially extended to contain waste bags.

### CROSS-REFERENCE TO RELATED APPLICATIONS

This application is a continuation-in-part of U.S. application Ser. No. 18/298,089, filed Apr. 10, 2023, and claims priority to U.S. Provisional Application No. 63/362,711, filed Apr. 8, 2022, both of which are hereby incorporated by reference herein in their entireties.

### BACKGROUND OF THE INVENTION

### Field of the Invention

Embodiments of the disclosed invention relate, in general, to devices, systems, and methods for containing and transporting bags of dog or other pet waste.

### Relevant Background

One of the most unpleasant aspects of walking or hiking with a dog is managing their solid waste. Typically, pet owners will carry waste bags with them to collect any waste left by their dog during the activity. These filled bags of waste are unpleasant to carry because they smell terrible and may have unsanitary waste on them that can get on hands and clothes. Carriers for pet waste bags exist in the art. One such product, the “Dog Doo Tube” is made of hard plastic, includes a snap-closed lid, and does not include an empty bag dispenser. This carrier is inferior at retaining odors, and is more inconvenient to carry due to its rigid exterior. Another waste carrier described in U.S. Pat. No. 10,058,074 B1, includes a fabric carrier with a removable rigid plastic container for filled waste bags, and lacks a spindle to hold a roll of unused bags. This waste carrier is more difficult to clean, and the rigid container is prone to loss or breakage and is less capable of odor containment. Similarly, the carrier described in U.S. Pub. No. 2008/0179902 A1, also includes an outer fabric cover, does not include a separate container for unused bags, and requires the use of specialized bags. U.S. Pub. No. 2009/0095225 A1 also includes a fabric cover and removable waste bag container, and does not have a spindle for dispensing unused bags. U.S. Pub. No. 2009/0151645 A1 is made of rigid metal, does not include a spindle for dispensing unused bags, and includes an additional compartment for wet wipes. U.S. Pub. No. 2011/0284544 A1 describes a flexible odor-sealing container, but has a complex and breakable flap-like seal, and does not include a spindle for dispensing unused bags. Further, none of these containers is collapsible.

What is needed, therefore, is a simple container for holding filled waste bags that seals in odors, is durable, light, easy to clean. Also needed is a container that meets all of the previous criteria, but also may be collapsed for easy transportation and storage, or expanded for filled waste bag storage. The disclosed invention addresses these needs and further provides an enclosed dispenser for empty waste bags, and a means for attaching the device to clothing or equipment for hands-free transport.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings and figures imbedded in the text below and attached following this description.

FIGS. 1A and 1B depict a side view of an embodiment of a waste bag carrier of the disclosed invention.

FIG. 2 depicts an internal side view of an embodiment of a waste bag carrier of the disclosed invention.

FIGS. 3A and 3B depict a side view of an embodiment of a waste bag carrier of the disclosed invention.

FIGS. 4A and 4B depict a top view of an embodiment of a waste bag carrier of the disclosed invention.

FIGS. 5A and 5B depict a side view of an embodiment of a waste bag carrier of the disclosed invention.

FIGS. 6A, 6B, and 6C depict a side view, a top perspective view, and a bottom perspective view, respectively, of an embodiment of a waste bag carrier of the disclosed invention.

FIG. 7 depicts an exploded top perspective view of an embodiment of a waste bag carrier of the disclosed invention.

FIG. 8 depicts a side view of an embodiment of a waste bag carrier of the disclosed invention.

FIGS. 9A and 9B each depicts a side view of a portion of an embodiment of a waste bag carrier of the disclosed invention.

FIGS. 10A, 10B, and 10C depict a side cutaway view, an enlarged partial cutaway view, and an enlarged partial cutaway view, respectively, of a portion of an embodiment of a waste bag carrier of the disclosed invention.

FIG. 11 depicts an exploded side view of a portion of an embodiment of a waste bag carrier of the disclosed invention.

FIGS. 12A, 12B, and 12C depict a side view, a bottom perspective view, and a bottom view, respectively, of a portion of an embodiment of a waste bag carrier of the disclosed invention.

FIGS. 13A, 13B, and 13C depict a side view, a top perspective view, and a top view, respectively, of a portion of an embodiment of a waste bag carrier of the disclosed invention.

FIGS. 14A, and 14B depict a side view, and a bottom view, respectively, of a portion of an embodiment of a waste bag carrier of the disclosed invention.

The Figures imbedded and attached depict embodiments of the disclosed invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The detailed description of the disclosed invention will be primarily, but not entirely, limited to devices for dispensing unused pet waste bags and carrying bags of pet waste while containing odor from the waste bags.

The disclosed invention will now be described in detail with reference to several embodiments thereof as illustrated in the accompanying Figures. In the following description, numerous specific details are set forth in order to provide a thorough understanding of embodiments of the disclosed application. It will be apparent, however, to one skilled in the art that embodiments may be practiced without some or all of these specific details. In other instances, well known process steps and/or structures have not been described in detail in order to not unnecessarily obscure the disclosed invention. The features and advantages of embodiments may be better understood with reference to the drawings and discussions that follow.

It should be apparent to those skilled in the art that the described embodiments of the disclosed invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the disclosed invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the disclosed invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### Waste Bag Carrier

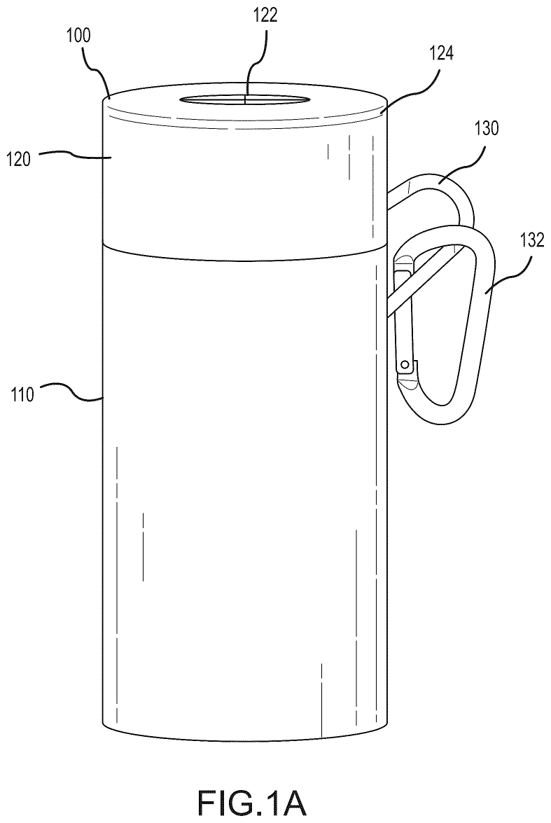

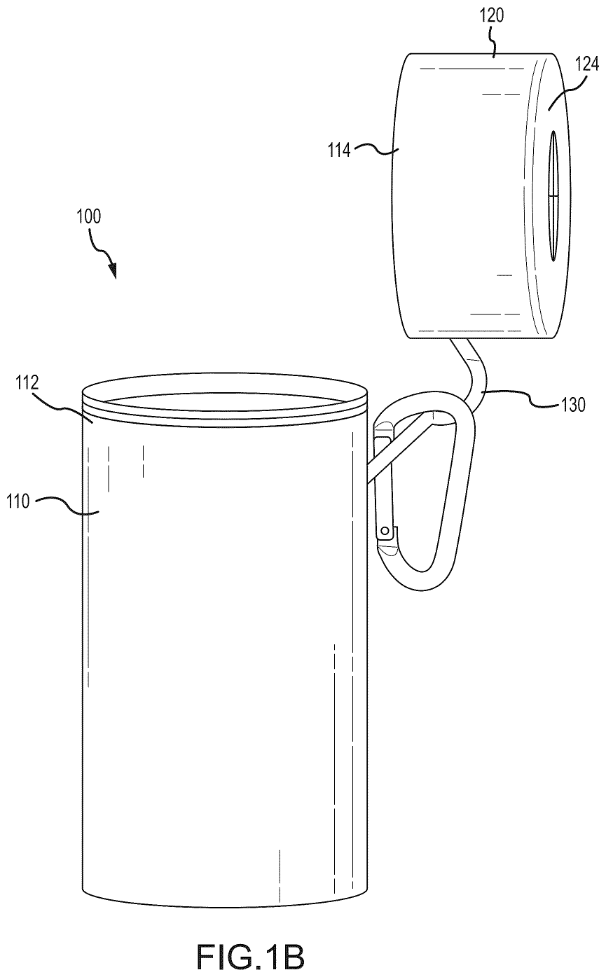

With reference to FIG. 1A, a side view of the waste bag carrier 100 is depicted. The carrier 100 has an overall cylindrical shape, although design variations are possible and contemplated, e.g., a cylinder with rounded corners, a cylindrical shape with a narrow lid, a rectangular prism, etc. The carrier has a main compartment 110 comprising the main body of the carrier, and a lid compartment 120 comprising a lid section of the carrier. The lid compartment 120 includes a cavity configured to carry a roll of unused pet waste bags (not shown), which may be fed through an opening or port 122 and removed from the lid compartment one at a time. The lid compartment fits dog waste bags of standard sizes that are commonly commercially available. The port 122 may comprise an opening in the lid that accommodates a flexible membrane having a cut-out, such as is commonly used in the art to dispense items separated by perforations, such as cleaning wipes, etc. Some embodiments may have an open port without the membrane. The lid compartment may have a volume of, for example, 8 ounces. The lid compartment also has a refill lid 124 that can be opened to refill the roll of unused waste bags. The refill lid 124 is removably attached to the lid compartment 120 by any suitable means known in the art, such as a hinge and latch system, a snap locking system, a set of mechanically interacting threads, a mechanically interacting tab and slot system, etc. Opposite the refill lid, the lid compartment has a sealed bottom panel (not shown), which helps keep odors sealed into the main compartment when the lid compartment is secured closed.

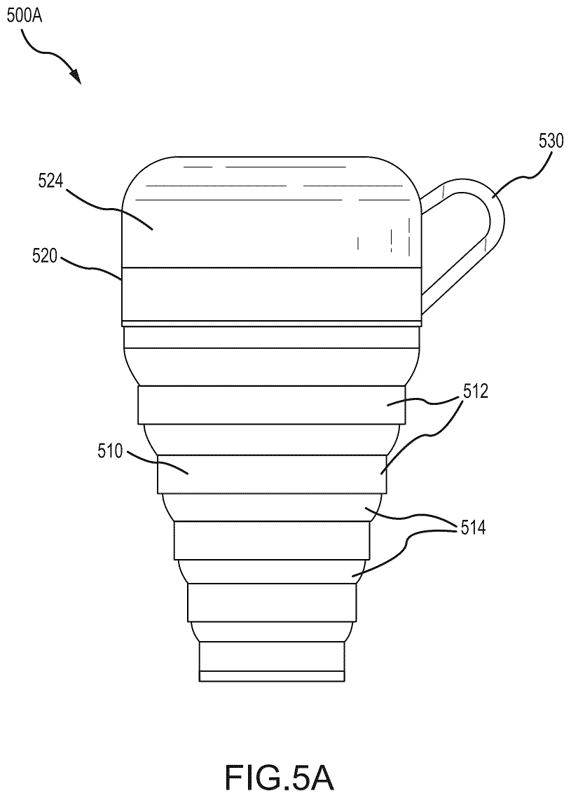

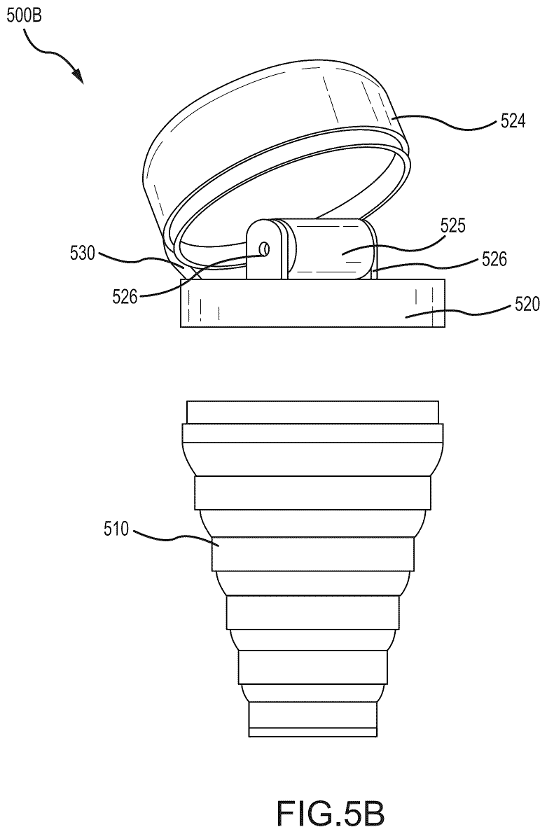

The main compartment 110 includes a cavity configured to carry one or more bags containing dog or other pet waste, and a sealed bottom panel opposite an opening. The lid compartment 120 forms a lid to close the opening and forms an odor-resistant or odor-proof seal to contain odor from the bags of pet waste. The lid compartment is removably attached to the main compartment 110 by any suitable means known in the art, such as a hinge and latch system, a set of mechanically interacting threads, a mechanically interacting tab and slot system, etc. In some embodiments, the main compartment is configured to hold up to 4 filled waste bags, and has a volume of, for example, 24 ounces. The overall dimensions of the carrier 100 may be, for example, 3.5 inches in diameter, and 8.25 inches in height. Other sizes are possible and contemplated, with more or less capacity to hold filled waste bags. Also depicted is a flexible connector 130 linking the main section to the lid section. The connector 130 is configured to keep the two container components connected while allowing the lid section to be opened and moved aside to provide access to the main compartment cavity. The connector 130 may be made from the same material or of a different material as the rest of the carrier. In some embodiments, the connector is fixedly attached to the carrier, in other embodiments, the connector is flexibly attached, and may turn or slide relative to the carrier body. In some embodiments, the connector 130 connects the lid compartment 120 to the refill lid 124 (See, e.g., FIG. 5A). The connector 130 may be fitted with an attachment means 132 suitable for removably attaching the carrier 100 to an article of clothing such as a belt loop, or a piece of equipment such as a backpack strap or dog leash. The attachment means 132 may be, e.g., a carabiner, a hook, a clasp, etc. The carrier has a body made of lightweight, durable material capable of sealing in odors. For example, the carrier body made me made from silicone, flexible plastic, aluminum, rubber, nylon, a polymer, etc. In particular, silicone construction would allow the carrier to seal away odors, while being durable, crushable, and easily cleaned. With reference to FIG. 1B, the carrier 100 is depicted with the lid section 120 opened, and moved away from the main compartment 110. In some embodiments, the lid 120 and the main compartment 110 are attached and sealed by means of a set of mechanically interlocking threads 112, 114.

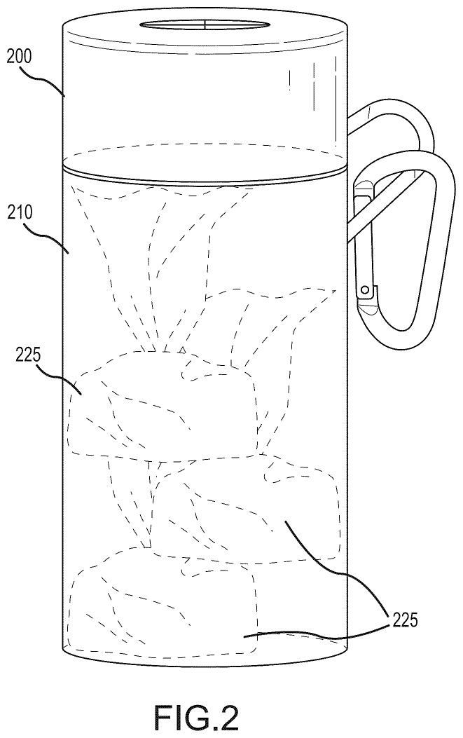

With reference to FIG. 2, a view of the disclosed carrier is depicted in which the sides of the carrier are translucent for illustrative purposes. The main compartment 210 is shown holding a number of filled waste bags 225.

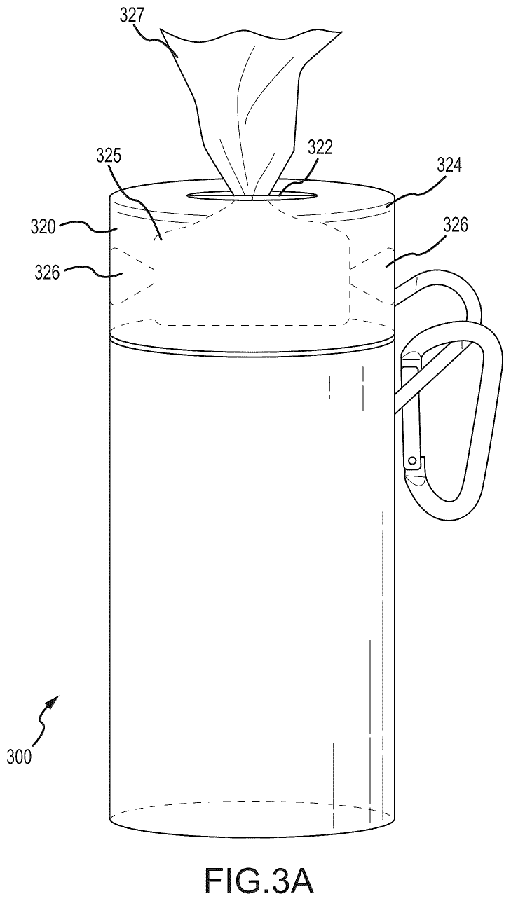

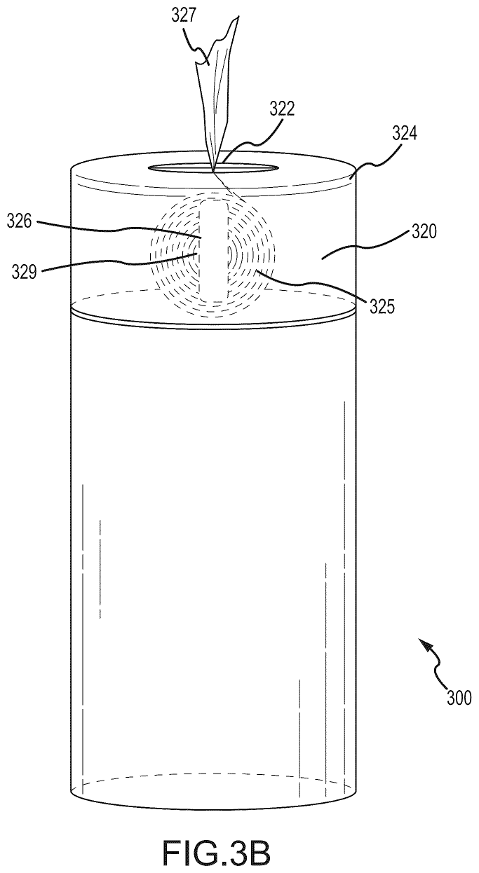

With reference to FIG. 3A, another view of the disclosed carrier 300 is depicted in which the sides of the carrier are translucent for illustrative purposes. In this view, a roll of unused waste bags 325 is depicted inside the lid compartment 320. The roll of waste bags 325 is removably attached inside the lid compartment 320 by a bag dispenser comprised of one or more clips or spindles 326 (two are shown) that are attached to the inner wall of the lid cavity and extend out to mechanically interact with the roll of waste bags, allowing the roll 325 to spin around its central axis when an individual bag 327 is pulled. In some embodiments, the spindle(s) are attached to the bottom panel of the lid compartment. Standard waste bags usually include a spool made of plastic or cardboard on which the bags are wound, in which case, the spindles mechanically interact with the spool. In some embodiments, the spindles 326 are spring-loaded, allowing them to be pushed aside to insert the roll and then to spring into place to hold the roll for use. Individual bags 327 are threaded through the port 322 and torn off when a bag is needed. When the roll is consumed, the refill lid 324 may be opened, and the empty spindle replaced with a new roll of waste bags. FIG. 3B depicts another view of the carrier 300, specifically the same view of FIG. 3A with the carrier rotated 90 degrees so that the roll of waste bags 325 is viewed from its end. A spindle 326 is shown interacting with the spool 329 at the center axis of the roll of bags 325.

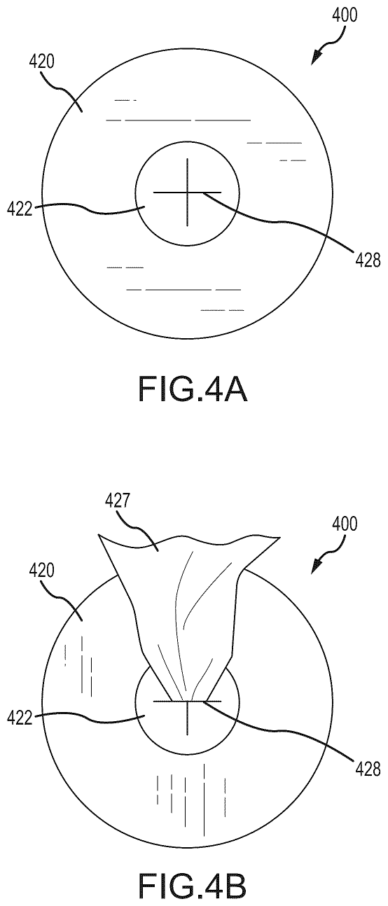

With reference to FIGS. 4A and 4B, a top-down view of the container 400 is depicted. The top surface of the lid section 420 is shown, along with the bag port 422, showing the membrane with a cut-out (a plus-shaped cutout is shown) 428 for dispensing individual bags. In some embodiments, the port 422 does not include a membrane, and is simply an opening in the top of the lid compartment. FIG. 4B shows a portion of an unused bag 427 pulled through the cut-out to be dispensed.

### Collapsible Waste Carriers

### Conical Main Compartment

With reference to FIGS. 5A and 5B two views of an alternative embodiment of the disclosed invention are depicted. FIG. 5A is a side view of a reversibly collapsible waste carrier 500A. The collapsible embodiment includes a main compartment 510 that can reversibly be placed in a fully extended configuration or a fully retracted configuration. Shown here, the main compartment is in the fully extended configuration, wherein the main compartment has capacity to hold one or more filled waste bags. The main compartment can be collapsed into a retracted position, which renders the waste carrier more compact for transport or storage. The main compartment may be partially collapsed or extended to an intermediate configuration. In some embodiments, the main compartment comprises a series of rigid or semi-rigid rings 512 that are connected by more flexible joint sections 514 that allow the main compartment to collapse, but also provide sufficient rigidity for the container to remain in an extended configuration. Like the other embodiments, the collapsible embodiments have a lid section 520 that is removably sealed to the main compartment. The lid section can be removed or opened to allow filled waste bags to be stored in the main compartment. When sealed, the lid section and main compartment mechanically interact to provide an odor-proof, or odor-resistant seal. Different connection means in the art are possible and contemplated, e.g., a snap closure, a screw top closure, a latch, or other suitable means. The lid section also includes a refill lid 524 that may be connected to the rest of the lid section 520 by a flexible connector 530. In some embodiments, the connector 530 connects the main compartment 510 to the lid compartment 520 (See, e.g., FIG. 1A). The refill lid can be opened to reveal a storage area for unused waste bags. With reference to FIG. 5B, an exploded side view of the collapsible waste carrier 500B is depicted. In this figure, the lid section 520 is removed from the main compartment 510, allowing access to the filled bag storage area. The refill lid 524 is shown in an open position revealing a roll of unused bags 525. The roll of unused bags is shown removably mounted on a bag dispenser comprising a pair of spindles 526. In some embodiments, the spindles are shown attached to sealed bottom surface of the lid compartment, however, the spindles may also be mounted to the sides of the lid compartment (See, e.g., FIG. 3A). The unused bags may be threaded through a port (not shown) in the top of the refill lid 524 for use. Once the roll of bags is consumed, the spool can be removed and a new roll of bags installed.

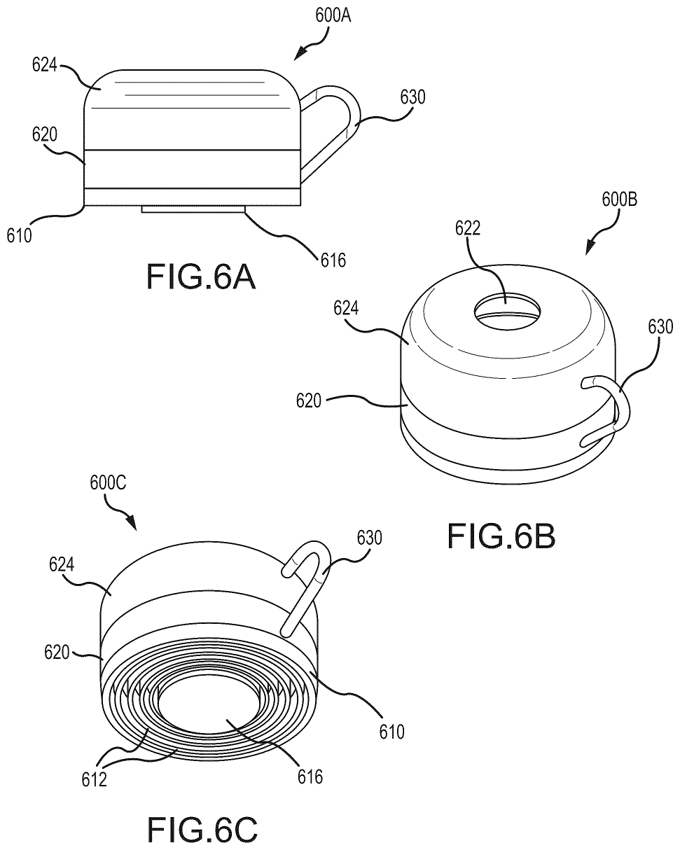

With reference to FIGS. 6A, 6B, and 6C, a side view, a top perspective view, and a bottom perspective view, respectively, of the collapsible embodiment are depicted in the fully collapsed configuration. FIG. 6A shows the collapsible waste carrier 600A with the main compartment 610 in a fully collapsed position. The waste carrier 600A is compact for easy transport and storage. In the fully collapsed configuration, the main compartment 610 is not capable of holding filled waste bags. The main compartment includes a handle area 616 to allow a user to extend the main compartment when desired. FIG. 6B shows the waste carrier 600B with the port 622 visible in the refill lid 624. In this embodiment the port does not include a membrane, but instead is an opening for pulling the unused bags (not shown) from the lid compartment as needed for use. Other embodiments may include a membrane with cut-outs for bag dispensing. FIG. 6C shows the waste carrier 600C in the fully collapsed configuration. As shown, the main compartment 610 is compact and the semi-rigid rings 612 as well as the central handle area 616 are visible.

### Cylindrical Main Compartment

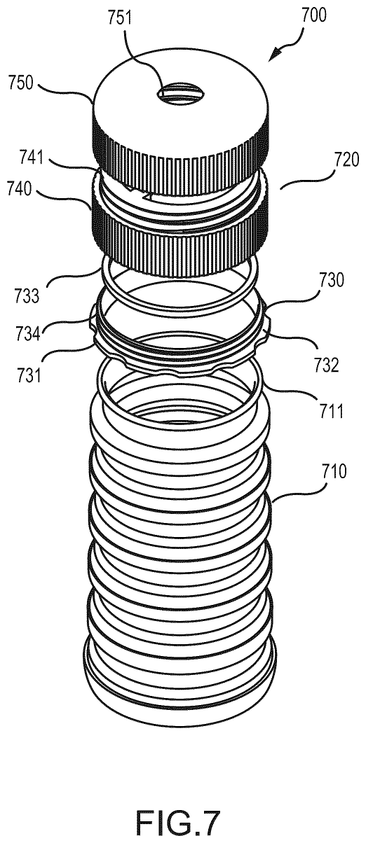

With reference to FIG. 7 is depicted an exploded top perspective view of an embodiment of a waste bag carrier 700 having a selectively expandible main compartment 710. The collapsible main compartment may be reversibly placed in a fully extended configuration, a fully retracted configuration, or in an intermediate configuration. When a user selects a configuration for the main compartment, it will tend to remain in the selected configuration until the user selects another configuration. Shown here, the main compartment is in the fully extended configuration, wherein the main compartment has capacity to hold one or more filled waste bags. The main compartment can be collapsed into a retracted position, which renders the waste carrier more compact for transport or storage. The main compartment may be partially collapsed or extended to an intermediate configuration to hold less than the carrier's full capacity of filled waste bags, while maintaining a more compact size than the fully extended configuration. In embodiments the main compartment is made from silicone, polyvinyl chloride, thermoplastic polyurethane, thermoplastic elastomer, ethylene propylene diene monomer, fluoroelastomer, or other suitable materials providing flexibility, durability and odor resistance.

Also included is a lid section 720 that is removably sealed to the main compartment 710. The lid section can be removed or opened to allow filled waste bags to be stored in the main compartment. When sealed, the lid section and main compartment mechanically interact to provide an odor-proof, or odor-resistant seal. Different connection means in the art are possible and contemplated, e.g., a snap closure, a screw top closure, a latch, or other suitable means. As shown, an adapter 730 is used to connect the lid section to the main compartment. The adapter includes a nut 731 for gripping the adapter, a gasket seat 732 for accommodating a gasket 733, and a set of threads 734 for mechanically interacting with a complimentary set of threads (not shown) on a lid cylinder 740. In embodiments, the lid section is made of polyester, nylon, polypropylene, aluminum, stainless steel, high density polyurethane, or other suitable material providing lightweight, durability, impact resistance, and odor containment. In embodiments, the gasket is made of natural rubber, silicone, thermoplastic elastomer, ethylene propylene diene monomer, or other suitable material for providing a flexible, durable, odor-proof seal.

The adapter fits over a top lip 711 of the main compartment, and the gasket is seated on the gasket seat. The lid cylinder 740 is then rotated to thread onto the adapter. When tightened, the lid cylinder forms a seal by pressing a sealing panel (not shown) against the gasket, which in turn is pressed against the gasket seat, and becomes securely attached to the main compartment.

The lid section 720 further includes a refill lid 750 that may be removably attached to the lid cylinder 740 by means of a set of threads (not shown) that mechanically interact with a complimentary set of threads 741 on a top side of the lid cylinder. When rotated relative to the lid cylinder and thereby tightened, the refill lid forms a seal with the lid cylinder to create a storage compartment for unused waste bags. The refill lid may be removed to access a roll of unused waste bags (not shown). The unused bags may be threaded through a port 751 in the top of the refill lid for use. Once the roll of bags is consumed, the spool can be removed and a new roll of bags installed. The lid cylinder may be flexibly attached to the main compartment, and/or flexibly attached to the refill lid for convenience and to prevent loss of components. The attachment means may be as described for other embodiments herein.

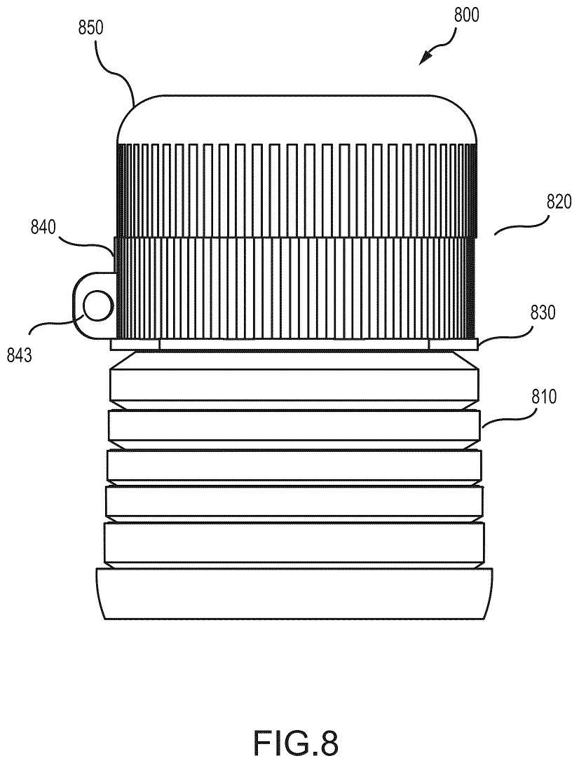

With reference to FIG. 8 is depicted a side view of a waste bag carrier 800 of the disclosed invention. In this view, the carrier is shown in an assembled configuration, with the main compartment 810 fully collapsed for easy storage or transport. In the fully collapsed configuration, the main compartment may accommodate zero, one, or more filled pet waste bags. The lid section 820 is shown removably attached and sealed with the main compartment to keep in odors. The adapter 830 connects the main compartment to the lid cylinder 840, which, in turn is connected to the refill lid 850. Also visible on the lid cylinder is an eyelet 843 for attaching a carabiner, d-ring, clip, hook, or other means suitable for removably connecting the carrier to a backpack, belt loop, strap, pocket, or other area for convenient transport and storage.

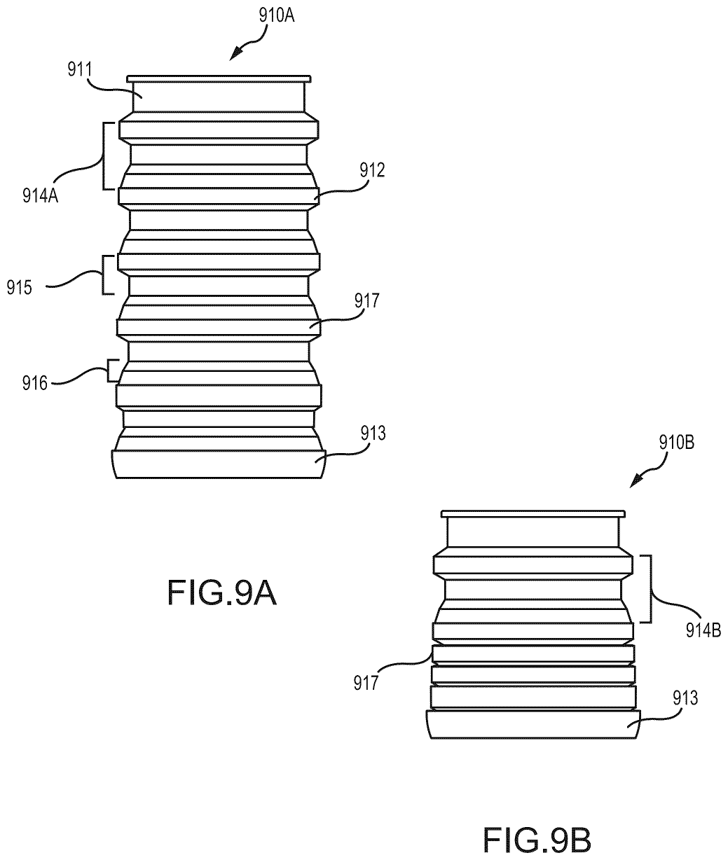

With reference to FIGS. 9A and 9B are depicted a side view of a portion of a waste bag carrier of the disclosed invention. FIG. 9A shows a main compartment 910A in a fully extended configuration. The main compartment includes a lip 911 at a top end, a cylindrical wall 912 for the sides, and a base 913 at a bottom end. The sides and base create a main cavity with an open top. The lip is configured to mechanically interact with the adapter (not shown) to form a seal with the lid section (not shown). The wall is of continuous construction, and includes a plurality of cylindrical main sections 914A (five are shown) that create a collapsible structure. Each section is comprised of a rigid subsection 915, and a jointed subsection 916. The rigid subsection is relatively stiffer than the jointed section, and includes an outer ring 917. To collapse a section, the rigid subsection is compressed into the jointed section, which folds onto itself so that the section's outer ring is adjacent to the outer ring of the next section. The bottom section folds into the base 913.

FIG. 9B shows the main compartment 910B in an intermediate configuration. In this case, the main section 914B nearest the top is in an extended configuration, and the remainder of the sections are in a collapsed configuration wherein the outer rings 917 are visible, while the remainder of the sections are folded within the outer rings or base. In this way, many intermediate configurations are possible, providing a main cavity with various internal volumes for storage of filled waste bags.

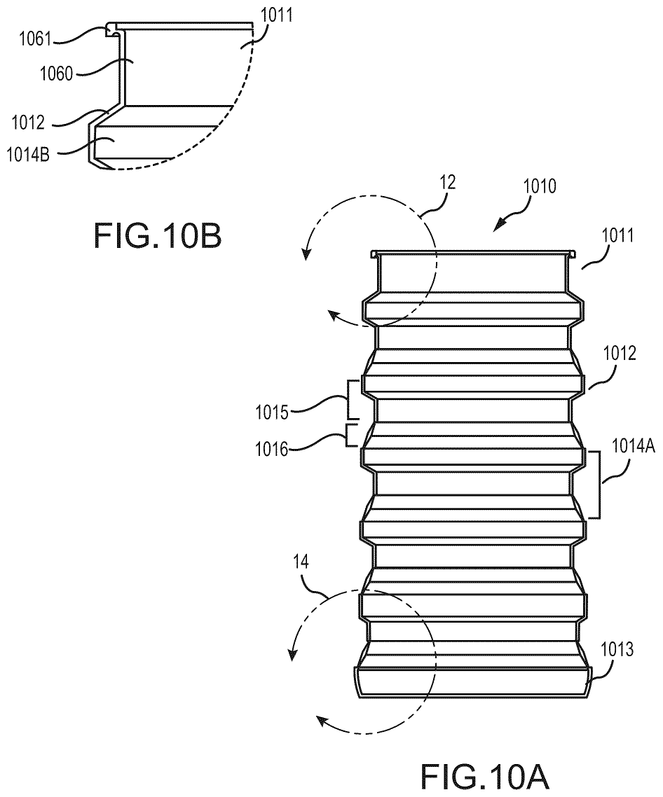

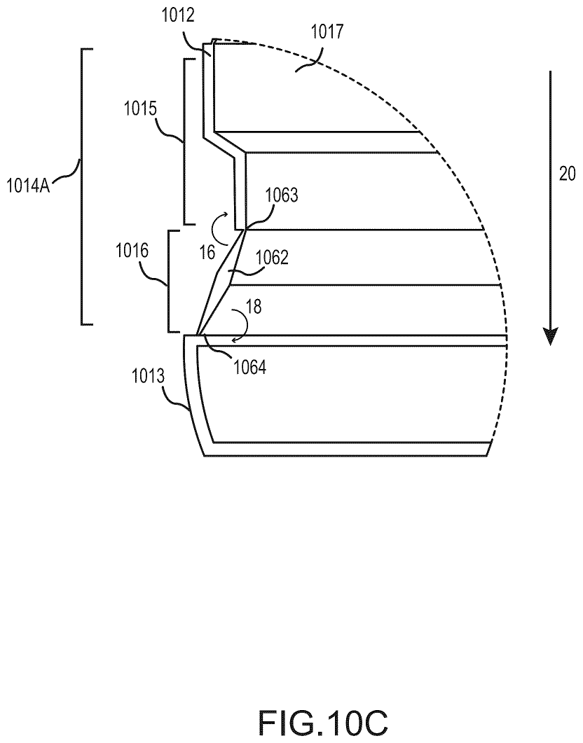

With reference to FIGS. 10A, 10B, and 10C are depicted a side cutaway view, an enlarged partial cutaway view, and an enlarged partial cutaway view, respectively, of a portion of a waste bag carrier of the disclosed invention. FIG. 10A shows a side cutaway view of a main compartment 1010 as used in some embodiments. The main compartment is shown in a fully extended configuration, and includes a lip 1011, a base 1013, and a plurality of sections 1014. Each section includes a rigid subsection 1015 and a jointed subsection 1016.

FIG. 10B shows an enlarged cutaway view of a portion of the main compartment as circumscribed by the arrow 12. The partial view shows the lip 1011 for mechanically interacting with the adapter (not shown). The lip includes a collar 1060, which accommodates the adapter on the main compartment. A flange 1061 is located at the top edge of the lip and extends outward from the collar to provide a surface for the adapter to tighten against when the lid cylinder (not shown) is threaded onto the adapter and tightened. Also visible is a cutaway view of the side wall 1062 of the main compartment, and a portion of the topmost main section 1014B. The sidewall 1012 is relatively rigid in this area so that when the main compartment is fully collapsed, the lip remains uncompressed to facilitate attachment to the lid section (not shown).

FIG. 10C shows an enlarged cutaway view of a portion of the main compartment as circumscribed by the arrow 14. A portion of the sidewall 1012 and base 1013 are shown along with the bottom section 1014C of the main compartment. While the bottom section mechanically interacts with the base when compressed, the function and structure are similar to that of other sections. The rigid subsection 1015 includes the outer ring 1017, which is the portion of the section that remains visible when the section is compressed into the base (or a lower section for the other sections). The jointed subsection 1016 is a specialized portion of the sidewall that includes a joint ring 1062 having an elongated diamond-shaped cross section, the joint ring connected to adjacent structures by two hinges 1063, 1064. An upper hinge 1063 attaches the joint ring to the rigid subsection 1015 above, and a lower hinge 1064 connects the joint ring to the base 1013 (or to the outer ring of a lower section for the other sections). The rigid subsection is relatively stiffer than the jointed subsection so that when a main section is compressed in the direction of the arrow 20, the upper hinge folds in the direction of the arrow 16, and the lower hinge folds in the direction of the arrow 18, allowing the main section 1014A to fold into the structure below so that the outer ring is located next to the base (or lower section). When extended, the jointed subsection 1016 tends to remain in place so that the section remains extended until a sufficient amount of compressive force causes the hinges to abruptly fold, allowing the section to compress.

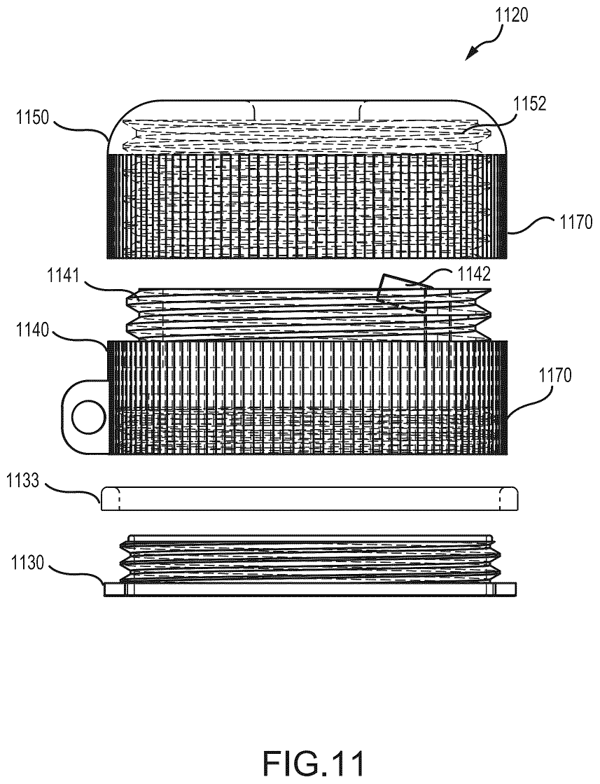

With reference to FIG. 11 is depicted an exploded side view of a portion of a waste bag carrier of the disclosed invention. Components of the lid section 1120 are shown in a translucent view to illustrate internal structures. The lid section includes an adapter 1130, a gasket 1133, a lid cylinder 1140, and a refill lid 1150. Additional features visible include knurling 1170 located around the sides of the refill lid and lid cylinder to improve a user's grip when tightening or loosening the components. The threads 1152 within the refill lid for mechanically interacting with the upper threads 1141 of the lid cylinder are also depicted. Also visible is a spindle 1142 for holding a roll of unused waste bags. The spindle is sized to accommodate the central spool around which the bags are wrapped so that the spool will turn on the spindle when bags are dispensed. The spindle is shown oriented at an approximate 10-degree angle to facilitate holding and dispensing the bags. Other configurations for holding the unused bags are possible and contemplated, including an additional spindle, clips, springs, or other structures, such as described herein for other embodiments.

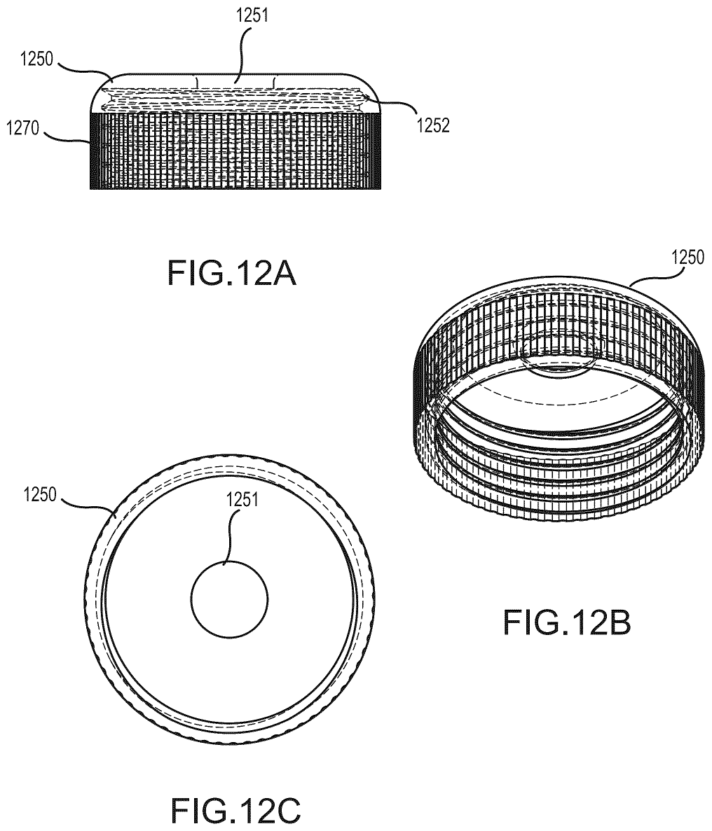

With reference to FIGS. 12A, 12B, and 12C are depicted a side view, a bottom perspective view, and a bottom view, respectively, of a portion of a waste bag carrier of the disclosed invention. Components of the refill lid 1250 are shown in a translucent view to illustrate internal structures. FIG. 12A shows a side view of the refill lid 1250, wherein the side knurling 1270, the internal threads 1252, and port 1251 are visible. The port is located in the center of the refill lid top, and is for dispensing unused bags stored in the lid compartment. The port may include a membrane made from, e.g., rubber, polymer, etc., to improve performance of the dispenser by aiding separating the bags and preventing multiple bags from dispensing at once. FIG. 12B shows the refill lid 1250 providing a view of the component's interior. FIG. 12C shows the underside of the refill lid 1250 wherein the port 1251 is visible in the center of the lid top.

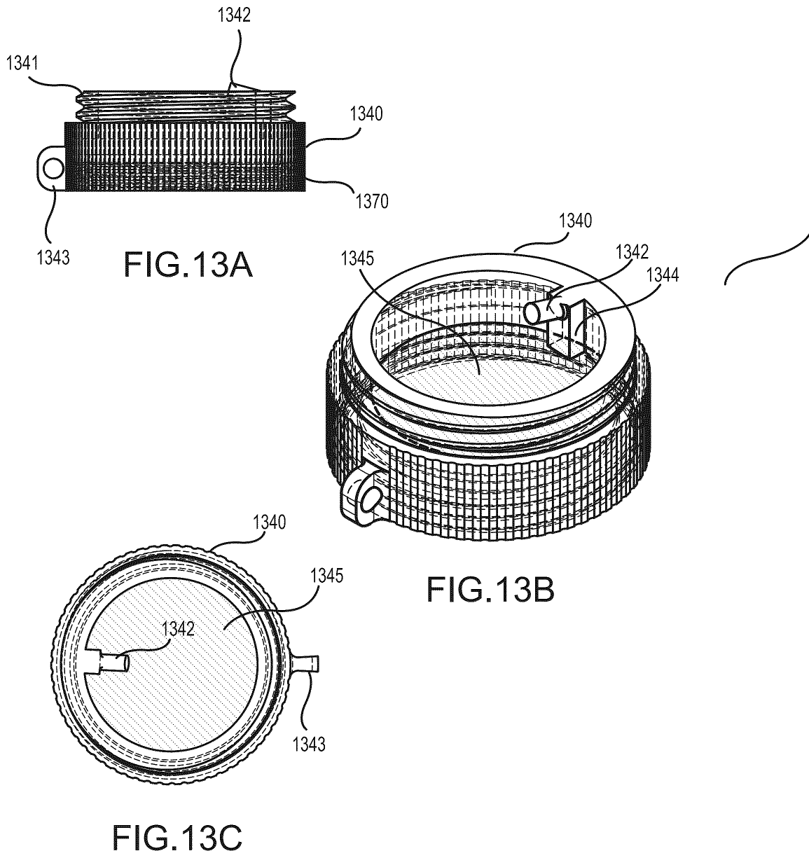

With reference to FIGS. 13A, 13B, and 13C are depicted a side view, a top perspective view, and a top view, respectively, of a portion of a waste bag carrier of the disclosed invention. Components of the lid cylinder 1240 are shown in a translucent view to illustrate internal structures. FIG. 13A shows the lid cylinder 1340 with external knurling 1370, eyelet 1343, threads 1341, and spindle 1342. FIG. 13B shows the lid cylinder 1340 providing a view of the component's interior. The bag roll spindle 1342 is shown attached to the interior wall of the lid cylinder. A spacer 1344 holds the spindle away from the interior wall to facilitate dispensing the unused bags. Directly beneath the spacer and above the lower threads is a sealing panel 1345 which extends across the lid cylinder and serves as a lid for the main compartment. The sealing panel forms an odor-proof seal by pressing against the gasket and the adapter. FIG. 13C shows the lid cylinder 1340 providing an alternate view of the spindle 1342, eyelet 1343, and sealing panel 1345.

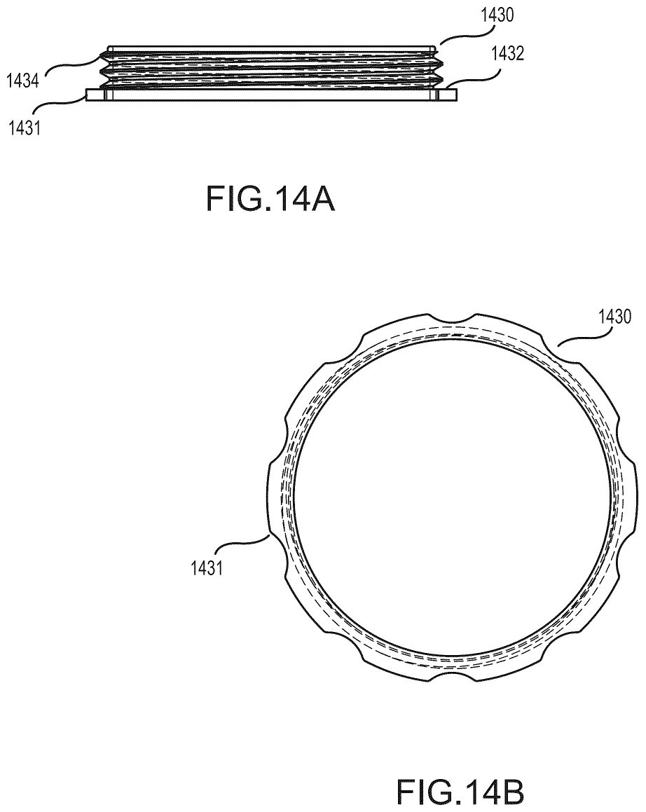

With reference to FIGS. 14A, and 14B are depicted a side view, and a bottom view, respectively, of a portion of a waste bag carrier of the disclosed invention. The adapter 1430 is shown in a translucent view to illustrate internal structures. FIG. 14A shows the adapter 1430, the nut 1431, gasket seat 1432, and threads 1434. FIG. 14B shows the adapter 1430 from below, providing a view of the nut 1431 wherein knurling is visible to facilitate grip of the adapter when tightening or loosening lid section components.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The attached description with reference to the accompanying drawings is provided to assist in a comprehensive understanding of exemplary embodiments of the disclosed invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the disclosed invention are provided for illustration purpose only and not for the purpose of limiting the invention as defined by the appended claims and their equivalents.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As will be understood by those familiar with the art, the disclosed invention may be embodied in other specific forms without departing from the spirit or essential characteristics thereof. Likewise, the particular naming and division of the modules, managers, functions, systems, layers, features, attributes, methodologies, and other aspects are not mandatory or significant, and the mechanisms that implement the invention or its features may have different names, divisions, and/or formats. Accordingly, the disclosure of the disclosed invention is intended to be illustrative, but not limiting, of the scope of the invention.

This has been a description of the disclosed invention along with a preferred method of practicing the invention.

What is claimed is:

1. A device for storage and transport of pet waste, comprising:
a main compartment, and a lid section;
wherein the lid section includes a lid compartment, a bag dispenser, a sealing panel located on a bottom of the lid compartment, and a removable refill lid located on a top of the lid compartment, the refill lid including a port, wherein the port is accessible when the lid compartment is in a closed position;
wherein the bag dispenser includes a spindle secured within the lid compartment, the spindle for mechanically interacting with a roll of empty bags; and
wherein the main compartment includes a main cavity and an opening, wherein a top of the main compartment removably attaches to the bottom of the lid compartment to form a seal for containing odors within the main cavity, the main compartment further comprising a plurality of main sections comprised of a rigid subsection and a jointed subsection, and wherein the main compartment is moveable among, and fixable in, an extended configuration, an intermediate configuration, and a storage configuration.

2. The device for storage and transport of pet waste of claim 1, the port further comprising a membrane.

3. The device for storage and transport of pet waste of claim 1, wherein the lid section is removably sealed to the main compartment by an adapter and a gasket.

4. The device for storage and transport of pet waste of claim 1, wherein the main compartment is selectively configurable to have a plurality of internal volumes.

5. The device for storage and transport of pet waste of claim 1, wherein the jointed subsection further comprises an upper hinge and a lower hinge.

6. The device for storage and transport of pet waste of claim 1, further comprising a connector that mechanically connects one of: the main compartment to the lid cylinder, or the lid cylinder to the refill lid.

7. A device, comprising:
a main compartment and a lid section, wherein a top of the main compartment forms a removable seal with the lid section, and when sealed, the main compartment contains odors;
wherein the main compartment further comprises a plurality main sections, wherein each of the plurality of main sections includes a rigid subsection and a jointed subsection, and wherein the main compartment is selectively configurable into one of a collapsed configuration, an extended configuration, and a plurality of intermediate configurations;
wherein the lid section further comprises a refill lid located on a top portion of, and removably connected to, a lid cylinder, the refill lid including a port, wherein the refill lid is accessible when the main compartment is sealed; and
a bag dispenser located in the lid section, wherein the bag dispenser includes a spindle for mechanically interacting with a roll of empty bags.

8. The device of claim 8, the port further comprising a membrane.

9. The device of claim 8, wherein the lid section is removably sealed to the main compartment by an adapter and a gasket.

10. The device of claim 8, wherein the main compartment is selectively configurable to have a plurality of internal volumes.

11. The device of claim 8, wherein the jointed subsection further comprises an upper hinge and a lower hinge.

12. The device of claim 8, further comprising a connector that mechanically connects one of: the main compartment to the lid cylinder, or the lid cylinder to the refill lid.
